(19) United States
(12) Patent Application Publication
(10) Pub. No.: US 2017/0169968 A1
(43) Pub. Date: Jun. 15, 2017

(54) SLIDING BUTTON COMPONENT AND ELECTRONIC PRODUCT

(71) Applicants: Le Holdings(Beijing)Co., Ltd., Beijing (CN); LEMOBILE INFORMATION TECHNOLOGY (BEIJING) CO., LTD ., Beijing (CN)

(72) Inventors: Shengmao Cai, Beijing (CN); Dun Tian, Beijing (CN); Fei Zhang, Beijing (CN)

(21) Appl. No.: 15/239,911

(22) Filed: Aug. 18, 2016

Related U.S. Application Data
(63) Continuation of application No. PCT/CN2016/087761, filed on Jun. 29, 2016.

(30) Foreign Application Priority Data
Dec. 9, 2015 (CN) 201521017927.2

(51) Int. Cl. H01H 15/10

(52) U.S. Cl. CPC H01H 15/10

(57) ABSTRACT

Disclosures are a sliding button component and an electronic product. The sliding button component includes: a centering sheet on which a first insertion groove is arranged; an elastic sheet including a connection section and an elastic arm extending out from the connection section, wherein the elastic arm is inclined relative to the connection section, and a second insertion groove is arranged on the connection section; and the centering sheet is arranged abutting the elastic sheet, and the elastic arm extends away from the centering sheet; and a button inserted in the first insertion groove and the second insertion groove. The sliding button component can prevent the sliding button from being loosening. One use of the sliding button component is applicable to a button on a mobile phone.

### CROSS REFERENCE TO RELATED APPLICATIONS

This application is a continuation of International Application No. PCT/CN2016/087761, filed on Jun. 29, 2016, which is based upon and claims priority to Chinese Patent Application No. 201521017927.2, filed with the Chinese Patent Office on Dec. 9, 2015 and entitled “Sliding button component and electronic product”, which is hereby incorporated by reference in its entirety.

### TECHNICAL FIELD

The present invention relates to the field of electronic products, and particularly to a sliding button component and electronic product.

BACKGROUND

Electronic products have become indispensable daily necessities in our lives, mobile phones, tablet computers, etc., have been more and more widely applied, and their functions have also become more and more diversified. At present, buttons which can slide upward and downward have been in used in various electronic products, but these buttons may frequently be slacked, blocked, loosened, etc., thus resulting in poor hand feelings.

The inventors have identified that it is necessary to improve the structure of the sliding buttons so as to avoid the problem above, and to improve their hand feelings s.

### SUMMARY

Embodiments of the invention provide a sliding button component and an electronic product, where the sliding button component can be prevented from being loosened.

An embodiment of the invention provides a sliding button component including:

a centering sheet on which a first insertion groove is arranged;

an elastic sheet including a connection section and an elastic arm extending out from the connection section, wherein the elastic arm is inclined relative to the connection section, and a second insertion groove is arranged on the connection section; and the centering sheet is arranged abutting the elastic sheet, and the elastic arm extends away from the centering sheet; and

a button inserted in the first insertion groove and the second insertion groove.

Furthermore an embodiment of the invention provides an electronic product including: a housing on the surface of which an installation groove is opened;

a sliding button component a comprising: a centering sheet on which a first insertion groove is arranged; an elastic sheet comprising a connection section and an elastic arm extending out from the connection section, wherein the elastic arm is inclined relative to the connection section, and a second insertion groove is arranged on the connection section; and the centering sheet is arranged abutting the elastic sheet, and the elastic arm extends away from the centering sheet; and a button inserted in the first insertion groove and the second insertion groove; wherein one end of the button passes the installation groove, and the centering sheet is arranged proximate to the housing; and

a positioning bracket arranged internal to the housing, wherein a limiting plane is arranged on the positioning bracket, and the elastic arm is pushed against the limiting plane.

In the sliding button component and the electronic product according to the embodiments of the invention, the elastic arm of the sliding button component can provide the sliding button component with an elastic force to prevent the sliding button component from being loosened.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a 3D structural diagram of a sliding button component according to an embodiment of the invention;

FIG. 2 is a side view of a sliding button component of the sliding button component according to the embodiment of the invention;

FIG. 3 is a 3D structural diagram of an elastic sheet according to an embodiment of the invention;

FIG. 4 is a side view of the elastic sheet according to the embodiment of the invention; and

FIG. 5 is a partial sectional view of an electronic product according to the embodiment of the invention.

### DETAILED DESCRIPTION

In order to make the objects, technical solutions, and advantages of the embodiments of the invention more apparent, the technical solutions according to the embodiments of the invention will be described below clearly and fully with reference to the drawings in the embodiments of the invention, and apparently the embodiments described below are only a part but not all of the embodiments of the invention. Based upon the embodiments here of the invention, all the other embodiments which can occur to those skilled in the art without any inventive effort shall fall into the scope of the invention.

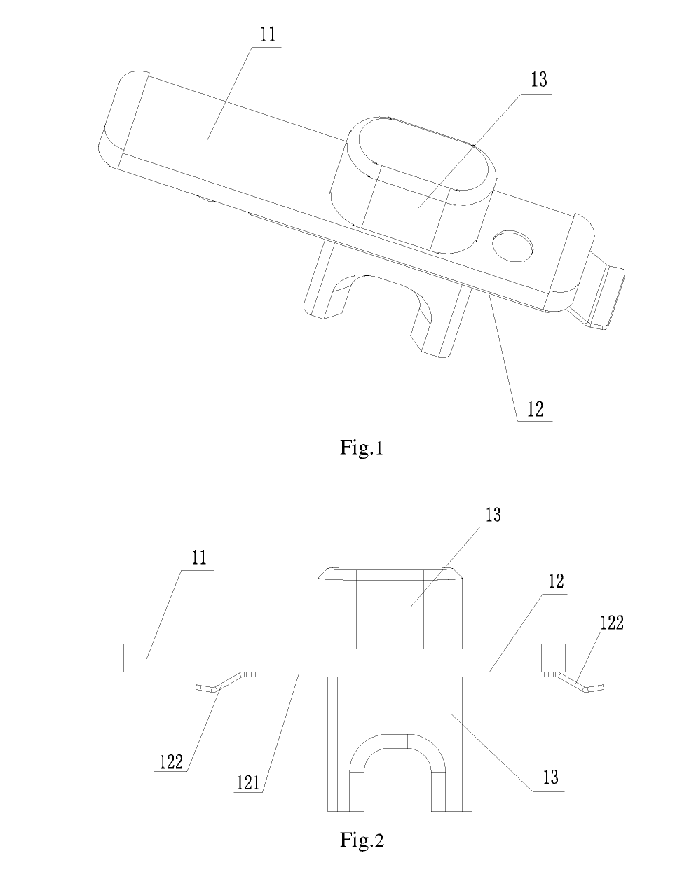

As illustrated in FIG. 1 and FIG. 2, an embodiment of the invention provides a sliding button component including a centering sheet 11, an elastic sheet 12, and a button 13. A first insertion groove is arranged on the centering sheet 11, and the elastic sheet 12 includes a connection section 121 and an elastic arm 122, where the elastic arm 122 extending out from the connection section 121 is inclined relative to the connection section 121, and a second insertion groove 123 is arranged on the connection section 121. As illustrated in FIG. 2, the centering sheet 11 is arranged abutting the elastic sheet 12, and in the embodiment illustrated in FIG. 2, both the centering sheet 11, and the connection section 121 of the elastic sheet 12 are structured planar, so the elastic sheet 12 can fit directly on the centering sheet 11. The elastic sheet 12 can fit to the centering sheet 11 through bonding, or another fitting structure can be arranged between them, although the embodiment of the invention will not be limited thereto. Particularly the elastic arm 122 on the elastic sheet 12 is inclined and extends toward the side thereof away from the centering sheet 11, so that the centering sheet 11 and the elastic sheet 12 form together an elastic structure. The button 13 passes the first insertion groove on the centering sheet 11, and the second insertion groove 123 on the connection section 121 of the elastic sheet 12, that is, the button 13 is inserted on the centering sheet 11 and the connection section 121. One end of the button 13 extends out from the centering sheet 11 side, and the other end of the button 13 can extend from the elastic sheet 12 side.

The sliding button component according to the embodiment of the invention can be installed in an electronic product, where the button 13 is exposed on a housing of the electronic product for an access by a user, and the centering sheet 11 functions to position and guide the sliding button component. A sliding groove can be arranged on the inside of the housing of the electronic product, so that the centering sheet 11 can be embedded in the sliding groove, and the user can push the button component to slide in the sliding groove. The elastic arm 122 of the elastic sheet 12 can be pushed against an internal structure of the electronic product to thereby apply an acting force toward the outside of the housing to the entire sliding button component, so that the sliding button component will not be loosened, and the operating user can feel some floating capacity of the button 13, thus improving feeling in use.

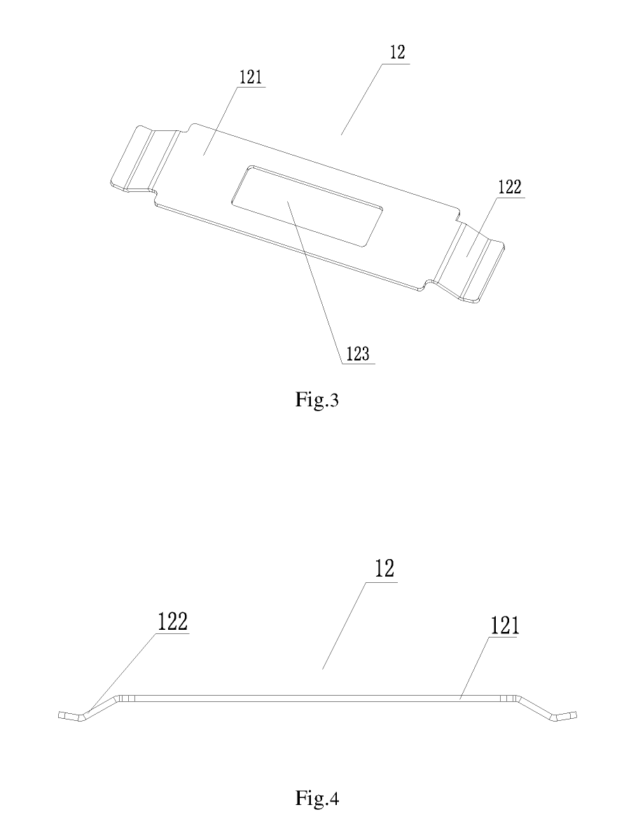

Particularly as illustrated in FIG. 3 and FIG. 4, in an embodiment of the invention, the elastic sheet 12 can include two elastic arms 122, where the connection section 121 can be structured in a planar rectangle, and the elastic arms 122 are arranged respectively on both ends of the connection section 121 structured in the planar rectangle, so that elastic forces generated by the elastic arms 122 can be transmitted uniformly to the centering sheet 11 and the button 13 to thereby improve the stability of the sliding button component in use. The shape of the elastic sheet 12, and the positions and the number of elastic arms 122 will not be particularly limited in the embodiment of the invention, but in another embodiment, for example, the connection section of the elastic sheet 12 can be an elliptical sheet, where the elastic arms 122 are arranged on both ends of the minor axis and the major axis of the elliptical sheet, so that there are four elastic arms 122 in total around the connection section. Those skilled in the art can adjust the shape of the connection section 121, and the number of elastic arms 122 dependent upon the direction in which the sliding button component slides, the condition under which the sliding button component is installed, and other factors.

In order to enable the elastic arms 122 to provide a good elastic effect so that the sliding button component can float stably and appropriately in the electronic product, and preferably as illustrated in FIG. 4, the elastic arm 122 is inclined relative to the connection section 121 at an angle which shall range from 20° to 50° . If the elastic arm 122 is inclined at a too large angle, then the elastic arm 122 will not be elastically deformed easily, and if the elastic arm 122 is inclined at a too small angle, then the elastic arm 122 will be deformed under a minor pressure, thus resulting in poor feeling in use. More preferably the elastic arm 122 can be inclined relative to the connection section 121 at an angle of 45° , where the elastic arm 122 can be elastically deformed and rebound as appropriate.

The strength of the elastic sheet 12 needs to be sufficient to provide good supporting and rebounding, so preferably in an embodiment of the invention, the width of the connection section 121 is more than 1 mm The strength of the connection section 121 with the width of more than 1 mm can be sufficient to provide good supporting, and if the width thereof is too small, then if the elastic arm 122 is curved, then the connection section 121 may be somewhat curved, thus degrading the reliability of the sliding button component.

Particularly in the embodiment illustrated in FIG. 2, the width of the connection section 121 can be substantially the same as the width of the centering sheet 11 to thereby facilitate sliding and engagement of the entire sliding button component in the electronic product. In another embodiment of the invention, the width of the connection section 121 can alternatively be more or less than that of the centering sheet 11, although the embodiment of the invention will not be limited thereto.

Particularly the button 13 can be designed in different structures dependent upon different real conditions of the electronic product, where the first insertion groove on the centering sheet 11, and the second insertion groove 123 on the elastic sheet 12 shall match in structure with the button 13. If there is no curving on the button 13, then in order to facilitate insertion of the button 13 into the first insertion groove and the second insertion groove 123, the centering sheet 11 and the elastic sheet 12 can be installed so that the first insertion groove and the second insertion groove 123 are aligned in position. If there is curving on the button 13, then the first insertion groove may be displaced from the second insertion groove 123. Relative positioning of the first insertion groove and the second insertion groove 123 in the embodiment of the invention will not be limited to their alignment in position with each other, but can be designed by those skilled in the art dependent upon the structure of the button 13.

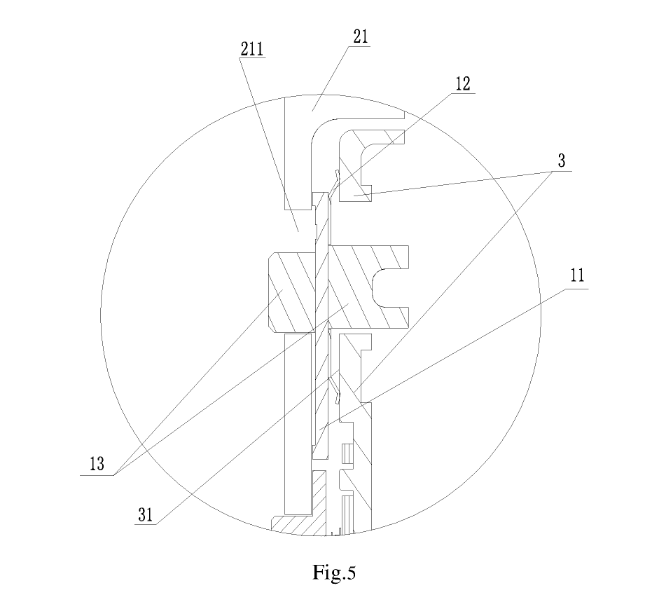

Furthermore an embodiment of the invention further provides an electronic product including a housing 21, the sliding button component according to any one of the embodiments above, and a positioning bracket 3. As illustrated in FIG. 5, an installation groove 211 is opened on the housing 21, and the sliding button component is installed on the inside of the housing 21, where the centering sheet 11 is arranged proximate to the inner surface of the housing 21, and one end of the button 13 passes the installation groove 211, and extends from the installation groove 211 to the outside of the housing 211, so that the user can slide the button 13 from the outside of the housing 21, and thus the sliding button component can slide in the direction in which the installation groove 211 extends. The elastic arm 122 of the elastic sheet 12 of the sliding button component extends toward the inside of the housing 21. The positioning bracket 3 is arranged internal to the housing 21, and a limiting plane 31 facing the sliding button component and the installation groove 211 is arranged on the positioning bracket 3. The elastic arm 122 on the elastic sheet 12 is pushed on the limiting plane 31. If the user pushes the button 13 from the outside of the housing 21, then typically a pressure normal to the surface of the housing 21 will be applied to the button 13, and if the elastic arm 122 of the elastic sheet 12 is subjected to the pressure, then the elastic arm 122 will be deformed, so that the entire sliding button component will move toward the inside of the housing 21 over a short distance. If the pressure applied by the user disappears, the elastic arm 122 being pushed against the limiting plane 31 will rebound, so that the entire sliding button component will move toward the outside of the housing 21 over a short distance, and return to the initial position. Thus the sliding button component will not be loosened due to the elastic arm 122 and the limiting plane 31; and moreover the user pressing the button 13 can feel some elastic force, thus improving feeling in use.

The position where the installation groove is opened in the housing 21 will not be limited in the embodiment of the invention, for example, in an embodiment, the housing 21 includes a large plane and a sidewall, where the installation groove 211 is arranged on the sidewall, the button 13 passes the sidewall, and the positioning bracket 3 can be fixed on the large plane through bonding, threading, etc., but the limiting plane 31 faces the installation groove 211, that is, the limiting plane 31 is not parallel to the large plane. In another embodiment, the housing can include a first plane and a second plane, where the first plane is parallel to the second plane. The installation groove is arranged on the first plane, and the positioning bracket 3 is arranged on the second plane, where the limiting plane faces the installation groove on the first plane, although those skilled in the art can design the structure of the housing 21, the position of the installation groove, and other features dependent upon a real condition.

An embodiment of the invention provides a sliding button component and an electronic product, where the sliding button component can be pushed by the elastic arm 122 of the elastic sheet 12 against the internal structure of the electronic product, and an acting force can be applied toward the outside of the housing 21 to the entire sliding button component, so that the sliding button component will not be loosened, and the operating user can feel some floating capacity of the button, thus improving feeling in use.

Lastly it shall be noted that the respective embodiments above are merely intended to illustrate but not to limit the technical solution of the invention; and although the invention has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the invention as claimed.

What is claimed is:

1. A sliding button component, comprising:
a centering sheet (11) on which a first insertion groove is arranged;
an elastic sheet (12) comprising a connection section (121) and an elastic arm (122) extending out from the connection section (121), wherein the elastic arm (122) is inclined relative to the connection section (121), and a second insertion groove (123) is arranged on the connection section (121); and the centering sheet (11) is arranged abutting the elastic sheet (12), and the elastic arm (122) extends away from the centering sheet (11); and
a button (13) inserted in the first insertion groove and the second insertion groove (123).

2. The sliding button component according to claim 1, wherein the elastic sheet (12) comprises two elastic arms (122), the connection section (121) is structured in a planar rectangle, and the elastic arms (122) are arranged respectively on both ends of the connection section (121).

3. The sliding button component according to claim 1, wherein the elastic arm (122) is inclined relative to the connection section (121) at an angle which ranges from 20° to 50°.

4. The sliding button component according to claim 3, wherein the elastic arm (122) is inclined relative to the connection section (121) at an angle of 45°.

5. The sliding button component according to claim 2, wherein the width of the connection section (121) is more than 1 mm.

6. The sliding button component according to claim 1, wherein the width of the centering sheet (11) is the same as the width of the connection section (121) of the elastic sheet (12).

7. The sliding button component according to claim 1, wherein the first insertion groove is aligned with the second insertion groove (123).

8. An electronic product, comprising:
a housing (21) on the surface of which an installation groove (211) is opened;
a sliding button component comprising:
a centering sheet (11) on which a first insertion groove is arranged; an elastic sheet (12) comprising a connection section (121) and an elastic arm (122) extending out from the connection section (121), wherein the elastic arm (122) is inclined relative to the connection section (121), and a second insertion groove (123) is arranged on the connection section (121); and the centering sheet (11) is arranged abutting the elastic sheet (12), and the elastic arm (122) extends away from the centering sheet (11); and a button (13) inserted in the first insertion groove and the second insertion groove (123);
wherein one end of the button (13) passes the installation groove (211), and the centering sheet (11) is arranged proximate to the housing (21); and
a positioning bracket (3) arranged internal to the housing (21), wherein a limiting plane (31) is arranged on the positioning bracket (3), and the elastic arm (122) is pushed against the limiting plane (31).

9. The electronic product according to claim 8, wherein the housing (21) comprises a large plane and a sidewall, wherein the installation groove (211) is arranged on the sidewall, the positioning bracket (3) is fixed on the large plane, and the limiting plane (31) faces the installation groove (211).
